(19) United States
(12) Patent Application Publication
(10) Pub. No.: US 2026/0196554 A1
(43) Pub. Date: Jul. 9, 2026

(54) COMPOSITION FOR FORMING SOLID ELECTROLYTE LAYER, SOLID ELECTROLYTE LAYER AND LITHIUM SECONDARY BATTERY

(71) Applicant: SK ON CO., LTD., Seoul (KR)

(72) Inventors: Kyeong Joon KIM, Daejeon (KR); Min Kyu KIM, Daejeon (KR); Do Kyeong LEE, Daejeon (KR); Eun Jeong YI, Daejeon (KR)

(21) Appl. No.: 19/444,189

(22) Filed: Jan. 9, 2026

(30) Foreign Application Priority Data
Jan. 9, 2025 (KR) 10-2025-0003526
Dec. 2, 2025 (KR) 10-2025-0188381

(51) Int. Cl. H01M 10/056; H01M 10/0525

(52) U.S. Cl. CPC H01M 10/056; H01M 10/0525; H01M 2300/0071; H01M 2300/0082

(57) ABSTRACT

A composition for forming a solid electrolyte layer according to embodiments of the present disclosure includes a ketone based solvent, a nitrile butadiene rubber binder, and inorganic electrolyte particles, wherein the acrylonitrile content in the nitrile butadiene rubber is 25 wt % to 50 wt %. The solid electrolyte layer according to embodiments of the present disclosure includes a ketone-based compound, a nitrile butadiene rubber, and inorganic electrolyte particles.

### CROSS-REFERENCE TO RELATED APPLICATIONS

This patent application claims the priority and benefits of Korean Patent Application No. 10-2025-0003526 filed on Jan. 9, 2025 and No. 10-2025-0188381 filed on Dec. 2, 2025, the disclosures of which are incorporated herein by reference in their entirety.

### BACKGROUND OF THE INVENTION

### 1. Field of the Invention

The present disclosure relates to a composition for forming a solid electrolyte layer, a solid electrolyte layer, and a lithium secondary battery.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has been actively developed and applied due to its high operating voltage, high energy density per unit weight, and advantages in charging speed and weight reduction.

Since commercially available lithium secondary batteries mainly use liquid electrolytes, there are safety issues such as leakage, ignition, and explosion due to sudden environmental changes, including temperature fluctuations, external impacts and the like. To address these problems, research has been conducted to solidify the electrolyte, thereby enhancing stability and increasing energy density.

All-solid-state batteries may include solid-state electrolytes such as gel polymers, oxides, sulfides, or composite polymers as electrolytes. Accordingly, stability against ignition and explosion caused by external impacts or external environmental fluctuations may be enhanced.

### SUMMARY OF THE INVENTION

An object of the present disclosure is to provide a composition for forming a solid electrolyte layer having improved dispersion stability.

Another object of the present disclosure is to provide a composition for forming a solid electrolyte layer having improved cohesive force.

Yet another object of the present disclosure is to provide a composition for forming a solid electrolyte layer with excellent adhesion to an electrode during slurry casting.

Still another object of the present disclosure is to provide a lithium secondary battery including a solid electrolyte layer prepared using the composition for forming a solid electrolyte layer.

A composition for forming a solid electrolyte layer according to exemplary embodiments may include: a ketone-based solvent; a nitrile butadiene rubber binder, and inorganic electrolyte particles, wherein the acrylonitrile content in the nitrile butadiene rubber may be 25% by weight to 50% by weight.

In some embodiments, the acrylonitrile content in the nitrile butadiene rubber may be 28% by weight to 40% by weight.

In some embodiments, the nitrite butadiene rubber may include hydrogenated nitrile butadiene rubber.

In some embodiments, the ketone based solvent may include at least one selected from the group consisting of methyl ethyl ketone, methyl propyl ketone, and methyl isobutyl ketone.

In some embodiments, the inorganic electrolyte particles may include an oxide based inorganic electrolyte.

In some embodiments, the oxide based inorganic electrolyte may include a garnet compound, a sodium super ionic conductor (NASICON) compound, a perovskite compound, a lithium super ionic conductor (LISICON)-based compound, a lithium phosphorus oxynitride (UPON)-based compound, Li₃BO_{2.5}N_{0.5}, Li₉SiAlO₈, or a combination thereof.

In some embodiments, the oxide-based inorganic electrolyte may include at least one selected from the group consisting of an LLTO-based compound, an LLZO based compound, a LATP-based compound, and an LAGP-based compound.

In some embodiments, the oxide based inorganic electrolyte may include an LLZO compound.

In some embodiments, a weight ratio of nano-LLZO to micro-LLZO in the LLZO compound may be 1:1 to 1:5.

In some embodiments, the viscosity of the composition may be 300 cp to 5000 cp.

In some embodiments, the cohesive force of the composition may be 0.1 N or more.

In some embodiments, the composition for forming a solid electrolyte layer may further include at least one additive selected from the group consisting of an unsaturated cyclic carbonate compound, a fluorine-substituted cyclic carbonate compound, a sultone compound, a cyclic sulfate compound, a fluorine-substituted phosphate compound, and an oxalato phosphate compound.

A solid electrolyte layer according to exemplary embodiments may include: a ketone-based compound; a nitrile butadiene rubber, and inorganic electrolyte particles.

In some embodiments, the acrylonitrile content in the nitrile butadiene rubber may be 28% by weight to 40% by weight.

In some embodiments, the nitrile butadiene rubber may include hydrogenated nitrile butadiene rubber.

In some embodiments, the ketone based compound may include at least one selected from the group consisting of methyl ethyl ketone, methyl propyl ketone, and methyl isobutyl ketone.

In some embodiments, the inorganic electrolyte particles may include an oxide based inorganic electrolyte.

In some embodiments, the oxide based inorganic electrolyte may include a garnet compound, a sodium super ionic conductor (NASICON) compound, a perovskite compound, a lithium super ionic conductor (LISICON)-based compound, a lithium phosphorus oxynitride (UPON)-based compound, Li₃BO_{2.5}N_{0.5}, Li₉SiAlO₈, or a combination thereof.

In some embodiments, the oxide-based inorganic electrolyte may include at least one selected from the group consisting of an LLTO-based compound, an LLZO based compound, a LATP-based compound, and an LAGP-based compound.

In some embodiments, the oxide based inorganic electrolyte may include an LLZO compound.

In some embodiments, a weight ratio of nano-LLZO to micro-LLZO in the LLZO-based compound may be 1:1 to 1:5.

In some embodiments, the solid electrolyte layer may further include at least one additive selected from the group consisting of an unsaturated cyclic carbonate compound, a fluorine-substituted cyclic carbonate compound, a sultone compound, a cyclic sulfate compound, a fluorine-substituted phosphate compound, and an oxalato phosphate compound.

A lithium secondary battery according to exemplary embodiments may include: a cathode; an anode disposed opposite the cathode; and the solid electrolyte layer interposed between the cathode and the anode.

The composition for forming a solid electrolyte layer according to exemplary embodiments may include a ketone based solvent, thereby improving the dispersion stability of the slurry.

The composition for forming a solid electrolyte layer according to exemplary embodiments may include a nitrile butadiene rubber binder containing acrylonitrile within a predetermined amount range, thereby improving interparticle cohesive force and electrode adhesion.

### BRIEF DESCRIPTION OF THE DRAWINGS

The above and other objects, features and advantages of the present disclosure will be more clearly understood from the following detailed description taken in conjunction with the accompanying drawing in which:

FIG. 1 is a schematic cross-sectional view of a secondary battery according to exemplary embodiments.

### DETAILED DESCRIPTION

A composition for forming a solid electrolyte layer according to exemplary embodiments of the present disclosure includes a ketone based solvent, a nitrile butadiene rubber binder, and inorganic electrolyte particles.

Hereinafter, exemplary embodiments of the present disclosure will be described in detail. However, these embodiments are merely illustrative, and the present disclosure is not limited to the specific embodiments described as examples.

As used herein, the term “solid electrolyte” may be used as a concept in contrast to a liquid electrolyte. For example, the solid electrolyte may include a quasi-solid electrolyte, a gel polymer electrolyte, or a semi-solid electrolyte.

As used herein, the term “composition for forming a solid electrolyte layer” may include a composition for forming a quasi-solid electrolyte layer, a composition for forming a gel polymer electrolyte layer, or a composition for forming a semi-solid electrolyte layer.

In exemplary embodiments, the composition for forming a solid electrolyte layer may include a ketone-based solvent, a nitrile butadiene rubber binder, and inorganic electrolyte particles.

The nitrile butadiene rubber may maintain a stronger bonding force on a metal surface of a current collector by strengthening coordination bonding via a nitrile ligand.

In some embodiments, the acrylonitrile content in the nitrile butadiene rubber may be 25% by weight (“wt %”) to 50 wt %. Within this range, interparticle cohesive force may be enhanced, and bonding force with an electrode may be excellent during casting of a slurry onto the electrode.

For example, if the acrylonitrile content in the nitrile butadiene rubber is less than 25 wt %, the interparticle cohesive force may be weak, and the bonding force with an electrode may be reduced during casting of a slurry onto the electrode.

For example, if the acrylonitrile content in the nitrile butadiene rubber is more than 50 wt %, the binder may not be sufficiently mixed into the composition for forming a solid electrolyte layer, thereby resulting in slurry agglomeration.

In some embodiments, the acrylonitrile content in the nitrile butadiene rubber may be 28 wt % to 40 wt %. For example, the acrylonitrile content in the nitrile butadiene rubber may be 28 wt % to 35 wt %. Within this range, the interparticle cohesive force may be further enhanced, thereby further enhancing the bonding force with an electrode during casting of a slurry onto the electrode.

In some embodiments, the nitrile butadiene rubber may include hydrogenated nitrile butadiene rubber. In this case, structural stability and electrochemical stability of the composition for forming a solid electrolyte layer may be improved.

In some embodiments, the nitrile butadiene rubber may be included in an amount of 0.1 wt % to 5 wt %, 1 wt % to 4 wt %, or 2 wt % to 3 wt % based on the total weight of the composition for forming a solid electrolyte layer.

Within the above range, the cohesive force and the stability of the composition for forming a solid electrolyte layer may be improved.

The ketone-based solvent may effectively disperse the inorganic electrolyte particles. The better the dispersibility of the inorganic electrolyte particles, the lower the viscosity and the shear stress of the composition, thereby facilitating the formation of the electrolyte layer and improving the performance of the resulting battery.

In some embodiments, the ketone based solvent may include at least one selected from the group consisting of methyl ethyl ketone, methyl propyl ketone, and methyl isobutyl ketone.

In some embodiments, the Hansen solubility parameter (δₜ²) of the ketone based solvents may be 15 Mpa^{0.5} to 28 Mpa^{0.5}.

The Hansen solubility parameter is a parameter related to solubility of a specific substance, determined by collectively considering dispersion force, dipole-dipole interaction, and hydrogen bonding force, and may be represented by Equation 1 below.

$${δ}_{t}^{2} = \sqrt{{δ}_{d}^{2} + {δ}_{p}^{2} + {δ}_{h}^{2}} \qquad [ Equation 1 ]$$

In Equation 1, δₜ² denotes the Hansen solubility parameter (MPa^{0.5}), δ_{d} denotes a solubility parameter due to dispersion force (MPa^{0.5}), δₚ denotes a solubility parameter due to dipole-dipole interaction (MPa^{0.5}), and δₙ denotes the solubility parameter due to hydrogen bonding force (MPa^{0.5}).

Within the above range, the interaction force between the ketone based solvent, the nitrite butadiene rubber binder, and the inorganic electrolyte particles may be appropriately maintained. Accordingly, the nitrile butadiene rubber may be readily dissolved in the ketone-based solvent, and the inorganic electrolyte particles may exhibit excellent dispersibility.

In some embodiments, the ketone based solvent may be included in an amount of 20 wt % to 50 wt %, 25 wt % to 40 wt %, or 30 wt % to 35 wt % based on the total weight of the composition for forming a solid electrolyte layer.

Within the above range, the binder and inorganic electrolyte particles may be appropriately dispersed, and the composition for forming a solid electrolyte layer may maintain an appropriate viscosity.

In some embodiments, the inorganic electrolyte particles may include an oxide based inorganic electrolyte.

In some embodiments, the oxide-based inorganic electrolyte may include an ion-conductive compound containing a metal and oxygen.

In some embodiments, the oxide based inorganic electrolyte may include a garnet compound, a sodium super ionic conductor (NASICON) compound, a perovskite compound, a lithium super ionic conductor (LISICON)-based compound, a lithium phosphorus oxynitride (LIPON)-based compound, Li₃BO_{2.5}N_{0.5}, Li₉SiAlO₈, or a combination thereof.

In some embodiments, the oxide based inorganic electrolyte may include a garnet compound, and the garnet compound may include a compound having a garnet crystal structure or a garnet-like crystal structure, such as an LLZO-based compound, Li₆La₂CaTa₂O₁₂, or Li₆La₂ANb₂O₁₂ (where A is Ca or Sr).

For example, the LLZO-based compound may be an oxide containing lithium, lanthanum, and zirconium. The LLZO-based compound may further include Al, Ga, In, Sc, Ba, Nb, etc. For example, the LLZO-based compound may include an LLZO compound (e.g., Li₇La₃Zr₂O₁₂) as well as doped variants thereof (e.g., Li_{6.4}La₃Zr_{1.4}Ta_{0.6}O₁₂).

In some embodiments, the NASICON compound may include a compound having a NASICON crystal structure or a NASICON-like crystal structure, such as a LATP-based compound, a LAGP-based compound, LiAlₓZr₂₋ₓ(PO₄)₃ (where 0≤x≤1), LiTiₓZr₂₋ₓ(PO₄)₃ (where 0≤x≤1), Li₂Nd₃TeSbO₁₂, etc.

For example, the LATP-based compound may be a phosphate containing lithium, aluminum, and titanium. For example, the LATP-based compound may include Li₁₊ₓAlₓTi₂(PO₄)₃ (where 0≤x≤0.5), specifically, Li_{1.3}Al_{0.3}Ti_{1.7}(PO₄)₃, etc.

For example, the LAGP-based compound may be a phosphate containing lithium, aluminum, and germanium. For example, the LAGP-based compound may include Li₁₊ₓAlₓGe₂₋ₓ(PO₄)₃ (where 0≤x≤0.5), such as Li_{1.5}Al_{0.5}Ge_{1.5}(PO₄)₃.

In some embodiments, the perovskite compound is a compound having a perovskite crystal structure or a perovskite-like crystal structure, and may include an LLTO-based compound having an ABO₃ structure.

For example, the LLTO-based compound may be an oxide containing lithium, lanthanum, and titanium. For example, the LLTO-based compound may include Li_{0.31}La_{0.56}TiO₃, Li_{0.34}La_{0.51}TiO₃, etc.

In some embodiments, the lithium super ionic conductor (LISICON)-based compound may include an amorphous quasi-three-dimensional (3D) frame, for example, a LiₓSiO₄—Li₃PO₄ composite structure may be used.

In some embodiments, the lithium phosphorus oxynitride (LIPON)-based compound may be represented by LiₓPO_{y}N_{z} (wherein 2.5≤x≤4.5, 2.5≤y≤4.5, and 0.05≤z≤0.6), and may include, for example, Li_{3.48}PO_{3.43}N_{0.14}.

For example, the oxide based inorganic electrolyte may be an LLZO-based compound (e.g., an LLZO compound or doped variants thereof, more specifically, Li₇La₃Zr₂O₁₂, Li_{6.4}La₃Zr_{1.4}Ta_{0.6}O₁₂), Li₆La₂CaTa₂O₁₂, Li₆La₂ANb₂O₁₂ (where A is Ca or Sr), a LATP-based compound (e.g., Li_{1.3}Al_{0.3}Ti_{1.7}(PO₄)₃), a LAGP-based compound (e.g., Li_{1.5}Al_{0.5}Ge_{1.5}(PO₄)₃), LiAlₓZr₂₋ₓ(PO₄)₃ (where 0≤x≤1), LiTiₓZr₂₋ₓ(PO₄)₃ (where 0≤x≤1), Li₂Nd₃TeSbO₁₂, an LLTO-based compound (e.g., Li_{0.31}La_{0.56}TiO₃, Li_{0.34}La_{0.51}TiO₃), a LISICON-based compound (e.g., a Li₄SiO₄—Li₃PO₄ composite structure), a UPON-based compound (e.g., Li_{3.48}PO_{3.43}N_{0.14}), Li₃BO_{2.5}N_{0.5}, Li₉SiAlO₈, or a combination thereof.

For example, the oxide based inorganic electrolyte may include at least one selected from the group consisting of an LLTO-based compound, an LLZO based compound, a LATP-based compound, and a LAGP-based compound.

In some embodiments, the oxide based inorganic electrolyte may include LLZO compound.

In some embodiments, a weight ratio of nano-LLZO to micro-LLZO in the LLZO-based compound may be 1:1 to 1:5. Within this range, the stability and the ionic conductivity of the composition for forming a solid electrolyte layer may be improved.

In some embodiments, the inorganic electrolyte particles may have a median particle diameter (D50) of about 100 nm to 5 μm. For example, the median particle diameter (D50) of the inorganic electrolyte particles may be about 150 nm to 3 μm or 200 nm to 1 μm.

Within the above range, the processability of the composition for forming a solid electrolyte layer may be secured while lithium-ion migration may be facilitated. The term “median particle diameter (D50)” may be defined as a particle diameter when a volume accumulation percentage in the particle size distribution obtained from the particle volume corresponds to 50%.

In some embodiments, the inorganic electrolyte particles may be included in an amount of 50 wt % to 80 wt % based on the total weight of the composition for forming a solid electrolyte layer. For example, the inorganic electrolyte particles may be included in an amount of 60 wt % to 70 wt % based on the total weight of the composition for forming a solid electrolyte layer. Within this range, the ionic conductivity of the composition for forming a solid electrolyte layer may be further improved, and the charge and discharge rate of the lithium secondary battery may be enhanced.

In some embodiments, the viscosity of the composition for forming a solid electrolyte layer may be 300 cp to 5000 cp. For example, the viscosity of the composition for forming a solid electrolyte layer may be 300 cp to 1500 cp. Within this range, the dispersion stability of the composition for forming a solid electrolyte layer may be improved, and the composition may be uniformly cast onto a substrate without agglomeration.

In some embodiments, the cohesive force of the composition for forming a solid electrolyte layer may be 0.1 N or more. Within this range, the stability of the composition and the bonding force with an electrode may be improved, and the stability during charge and discharge of the lithium secondary battery may be improved.

In some embodiments, the composition for forming a solid electrolyte layer may further include at least one additive selected from the group consisting of an unsaturated cyclic carbonate compound, a fluorine-substituted cyclic carbonate compound, a sultone compound, a cyclic sulfate compound, a fluorine-substituted phosphate compound, and an oxalato phosphate compound.

The unsaturated cyclic carbonate compound may include vinyl ethylene carbonate (VEC), vinylene carbonate (VC), etc.

The fluorine-substituted cyclic carbonate compounds may include fluoroethylene carbonate (FEC).

The sultone compounds may include 1,3 propane sultone, 1,3-propene sultone, 1,4-butane sultone, etc.

The cyclic sulfate compounds may include 1,2-ethylene sulfate, 1,2-propylene sulfate, etc.

The fluorine-substituted phosphate compound may include lithium difluorophosphate (LiPO₂F₂), etc.

The oxalato phosphate compound may include lithium difluorobis(oxalato)phosphate, etc.

These compounds may be used alone or in combination of two or more thereof.

The content of the additive may be about 0.01 wt % to 5 wt % based on the total weight of the composition for forming a solid electrolyte layer.

The solid electrolyte layer according to the present disclosure includes the ketone-based compound, the nitrile butadiene rubber, and the inorganic electrolyte particles. The ketone based compound may be a compound derived from the above-described ketone based solvent.

The nitrile butadiene rubber and the inorganic electrolyte particles may be the same as those described above.

The solid electrolyte layer may be formed from the composition for forming a solid electrolyte layer. The solid electrolyte layer may be formed by thermal polymerization or photopolymerization of the composition for forming a solid electrolyte layer.

For example, the composition for forming a solid electrolyte layer may be applied onto a porous film or an electrode substrate, and heated (thermal polymerization) or irradiated with light (photopolymerization) to form the solid electrolyte layer. Alternatively, the composition for forming a solid electrolyte layer may be introduced into a mold having a predetermined shape, and polymerized by heating (thermal polymerization) orby light irradiation (photopolymerization) to form the solid electrolyte layer.

When the composition for forming a solid electrolyte layer is thermally polymerized, the solid electrolyte layer may be formed by allowing the composition to stand at a temperature of about 50° C. to 150° C. for about 20 to 60 minutes.

According to exemplary embodiments, the thickness of the solid electrolyte layer may be about 10 μm to 200 μm. In some embodiments, the thickness of the solid electrolyte layer may be about 15 μm to 150 μm.

A lithium secondary battery according to the present disclosure includes a cathode, an anode disposed opposite the cathode, and a solid electrolyte layer interposed between the cathode and the anode.

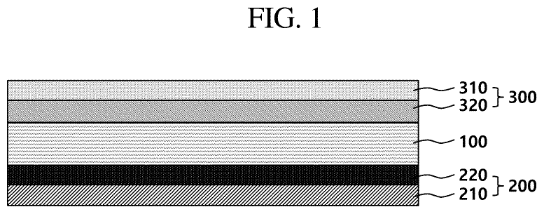

FIG. 1 is a schematic cross-sectional view of a secondary battery according to exemplary embodiments.

Referring to FIG. 1, the secondary battery includes a cathode 300, an anode 200 disposed opposite the cathode 300, and a solid electrolyte layer (electrolyte layer 100) disposed between the cathode 300 and the anode 200, and prepared from the composition for forming a solid electrolyte layer.

The cathode 300 may include a cathode current collector 310 and a cathode active material layer 320 disposed on at least one surface of the cathode current collector 310.

The cathode current collector 310 may include stainless steel, nickel, aluminum, titanium, or an alloy thereof. The cathode current collector 310 may also include aluminum or stainless steel whose surface is treated with carbon, nickel, titanium, or silver. The thickness of the cathode current collector may be, for example, 10 μm to 50 μm.

The cathode active material layer 320 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

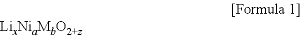

In Formula 1, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Formula 1 indicates a bonding relationship among elements included in the layered structure or the crystal structure of the cathode active material, and does not exclude the presence of additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity/output activity of the cathode active material together with Co or Mn, such as Al.

For example, the cathode active material or the lithium-nickel metal oxide may include a layered structure or a crystal structure represented by Formula 1-1 below.

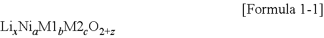

In Formula 1-1, M1 may include Co, Mn and/or Al. M2 may include the auxiliary elements described above. In Formula 1-1, x, a, b, c and z may satisfy 0.9≤x≤1.2, 0.6≤a≤0.99, 0.01≤b+c≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may be present on the surface of lithium-nickel metal oxide particles, or may penetrate through the surface of the lithium-nickel metal oxide particles to be incorporated into the bonding structure represented by Formula 1 or Formula 1-1 above.

The cathode active material may include a nickel-cobalt-manganese (NCM-based lithium oxide. In this case, an NCM-based lithium oxide having an increased content of nickel may be used.

Nickel (Ni) may serve as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

However, as the Ni content increases, the long-term storage stability and cycle life stability of the cathode or the secondary battery may be relatively reduced, and side reactions with the electrolyte may also increase. Nevertheless, according to exemplary embodiments, by including Co, the cycle life stability and capacity retention characteristics may be improved by Mn, while electrical conductivity is maintained.

The content of Ni (e.g., the molar fraction of nickel based on the total molar amount of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide based active material, a lithium manganese oxide-based active material, a lithium nickel oxide-based active material, or a lithium iron phosphate (LFP)-based active material (e.g., LiFePO₄).

In some embodiments, the cathode active material may include, for example, a manganese (Mn)-rich active material, a lithium (Li)-rich layered oxide (LLO)/over-lithiated oxide (OLO)-based active material, or a cobalt (Co)-less active material, which has a chemical structure or a crystal structure represented by Formula 2 below.

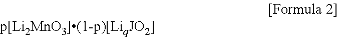

In Formula 2, p and q may satisfy 0<p<1, and 0.9≤q≤1.2, and J may include at least one element selected from Mn, Ni, Co, Fe, Cr, V, Cu, Zn, Ti, Al, Mg and B.

For example, a cathode slurry may be prepared by mixing a solvent and the cathode active material. The cathode slurry may be coated on the cathode current collector 310, followed by drying and roll-pressing to prepare the cathode active material layer 320. The coating process may be performed using methods such as gravure coating slot die coating simultaneous multilayer die coating imprinting doctor blade coating dip coating, bar coating or casting etc., but is not limited thereto. The cathode active material layer may further include a binder and optionally may further include a conductive material, a thickener or the like.

Non-limiting examples of the solvent used in the preparation of the cathode slurry may include N-methyl-2-pyrrolidone (NMP), dimethylformamide, dimethylacetamide, N,N-dimethylaminopropylamine, ethylene oxide, tetrahydrofuran or the like.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly(butadiene) rubber (BR), styrene-butadiene rubber (SBR) and the like. In one embodiment, a PVDF-based binder may be used as the cathode binder.

The conductive material may be added to the cathode active material layer to enhance the conductivity thereof and/or the mobility of lithium ions or electrons. For example, the conductive material may include carbon based conductive materials such as graphite, carbon black, acetylene black, Ketjen black graphene, carbon nanotubes, vapor-grown carbon fibers (VGCF), and carbon fibers; and/or metal-based conductive materials such as tin, tin oxide, and titanium oxide; as well as perovskite materials such as LaSrCoO₃, and LaSrMnO₃, but is not limited thereto.

The cathode slurry may further include a thickener and/or a dispersant, as needed. In one embodiment, the cathode slurry may include a thickener such as carboxymethyl cellulose (CMC).

If necessary, the cathode active material layer may further include the above-described inorganic electrolyte particles. For example, the cathode active material layer may further include the above-described oxide based inorganic electrolyte. In this case, the inorganic electrolyte particles included in the solid electrolyte layer and the inorganic electrolyte particles included in the cathode active material layer may be the same or different.

The anode 200 may include an anode current collector 210 and an anode active material layer 220 disposed on at least one surface of the anode current collector 210.

The anode current collector 210 may include, for example, a copper foil, nickel foil, stainless steel foil, titanium foil, nickel foam, copper foam, or a polymer substrate coated with a conductive metal. The anode current collector 210 may have a thickness of, for example, 10 μm to 50 μm, but is not limited thereto.

The anode current collector 210 is not an essential component and the anode 200 may include only the anode active material layer 220 without the anode current collector 210.

The anode active material layer 220 may include an anode active material. As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used.

Examples of the amorphous carbon may include hard carbon, soft carbon, coke, mesocarbon microbead (MCMB), mesophase pitch-based carbon fiber (MPCF) or the like.

Examples of the crystalline carbon may include graphite-based carbon such as natural graphite, artificial graphite, graphitized coke, graphitized MCMB, graphitized MPCF or the like.

The lithium metal may include pure lithium metal or lithium metal having a protective layer formed thereon for suppressing dendrite growth, etc. In one embodiment, a lithium metal-containing layer deposited or coated on the anode can ent collector may be used as the anode active material layer. In one embodiment, a lithium thin-film layer may be used as the anode active material layer.

Elements contained in the lithium alloy may include aluminum, zinc, bismuth, cadmium, antimony, silicon, lead, tin, gallium or indium, etc.

The silicon-containing material may provide further increased capacity characteristics. The silicon-containing material may include Si, SiOₓ (0<x<2), a metal-doped SiOₓ (0<x<2), a silicon-carbon composite, etc. The metal may include lithium and/or magnesium, and the metal-doped SiOₓ (0<x<2) may include a metal silicate.

If necessary, the anode active material layer may further include the above-described inorganic electrolyte particles. For example, the anode active material layer may further include the above-described oxide-based inorganic electrolyte. In this case, the inorganic electrolyte particles included in the solid electrolyte layer and the inorganic electrolyte particles included in the anode active material layer may be the same or different.

For example, an anode slurry may be prepared by mixing the anode active material in a solvent. The anode slurry may be coated or deposited onto the anode current collector, and then dried and roll-pressed to prepare the anode active material layer 220. The coating process may be performed using substantially the same method as the method of preparing the cathode active material layer 320. The anode active material layer 220 may further include a binder, and optionally may further include an electrolyte, a conductive material, a thickener, etc.

In some embodiments, the anode 200 may include the anode active material layer in the form of a lithium metal formed through a deposition/coating process.

The solvent for the anode active material layer may include, for example, water, purified water, deionized water, distilled water, ethanol, isopropanol, methanol, acetone, n-propanol, t butanol, etc.

The above-described materials that can be used when preparing the cathode as the binder, conductive material and thickener may also be used for the anode.

In some embodiments, a styrene butadiene rubber-based binder, carboxymethyl cellulose, polyacrylic acid based binder, poly(3,4-ethylenedioxythiophene) (PEDOT)-based binder, and the like may be used as an anode binder.

In some embodiments, the electrolyte layer 100 may be interposed between the cathode 300 and the anode 200 within the electrode assembly. For example, an electrode cell may be defined by the cathode 300, the anode 200 and the electrolyte layer 100, and a plurality of the electrode cells may be stacked to form an electrode assembly. For example, the electrode assembly may be formed by winding stacking folding or the like.

For example, electrode tabs (cathode tabs and anode tabs) may protrude from the cathode current collector and the anode current collector, respectively, and may extend to one side of a case. The electrode tabs may be welded together with the one side of the case and connected to electrode leads (a cathode lead and an anode lead) that extend or are exposed to the outside of the case.

In exemplary embodiments, the electrode cell may be formed by interposing the solid electrolyte layer prepared from the composition for forming a solid electrolyte layer between the cathode 300 and the anode 200.

For example, a pouch-type case, a prismatic case, a cylindrical case, or a coin-type case, etc. may be used as the case.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Example 1

### (1) Preparation of Solid Electrolyte Layer

A binder solution containing 10 wt % NBR was prepared by uniformly mixing 0.96 g of NBR binder (AN 34 wt %) and 8.64 g of MPK at room temperature using magnetic bar stirring for 48 hours. A ball milling bottle was then loaded with 5 mm Zr balls and 3 mm Zr balls at a ratio of 3:1, followed by sequential addition of 8 g of nano-LLZO (about 300 nm), 24 g of micro-LLZO (about 1 μm), the binder solution, and 7.36 g of an MPK solvent. The mixture was then ball-milled for about 24 hours to prepare the composition for forming a solid electrolyte layer.

The composition for forming a solid electrolyte layer was thinly applied onto an upper portion of an anode substrate (areal capacity: 4 mAh cm⁻²) made of Si—C with a silicon content of 11 wt %, and then heat-treated at 90° C. for 30 minutes to form the solid electrolyte layer.

Next, a polymer electrolyte composition was prepared by adding 5 wt % of trimethylolpropane ethoxylate triacrylate (TMPETA), 1 wt % of t butylperoxypivalate (t-BPP), 16.9 wt % of LiTFSI, 2.1 wt % of LiDFOB, and 0.6 wt % of LiPF₆ to a solvent containing 50.7 wt % of EMC and 23.7 wt % of FEC.

The polymer electrolyte composition prepared above was impregnated onto the solid electrolyte layer.

### (2) Manufacture of Lithium Secondary Battery

A cathode slurry was prepared by mixing LiNi_{0.88}Co_{0.06}Mn_{0.06}O₂ as a cathode active material, polyvinylidene fluoride (PVDF; Kynar Flex® 2851, Arkema) as a binder, and Ketjen Black as a conductive material with N-methyl-2-pyrrolidone as a solvent in a mixer (Thinky mixer) at a weight ratio of 96.5:1.5:2.0, by simultaneous rotation and revolution for 30 minutes. The cathode slurry was uniformly applied onto an aluminum foil, vacuum-dried at about 120° C., and roll-pressed to fabricate a cathode (loading amount: about 15 mg/cm², composite density: about 2.5 g/cm³). The specific capacity of the cathode was 4 mAh cm⁻².

The cathode was stacked onto the solid electrolyte layer to assemble a cell. The assembled cell was thermally cured in an oven at about 60° C. for about 1 hour to manufacture a battery.

### Examples and Comparative Examples

Solid electrolyte layers and batteries were manufactured in the same manner as in Example 1, except that the AN content of the NBR binder and the type of solvent in the composition for forming an electrolyte were adjusted as shown in Table 1 below.

TABLE 1

| | AN content in NBR binder | |
|---|---|---|
| | (wt %) | Solvent type |
| Example 1 | 34 | MPK |
| Example 2 | 28 | MPK |
| Example 3 | 40 | MPK |
| Example 4 | 34 | MEK |
| Example 5 | 34 | MIBK |
| Example 6 | 34 | DIBK |
| Example 7 | 45 | MPK |
| Comparative Example 1 | 18 | MPK |
| Comparative Example 2 | 60 | MPK |
| Comparative Example 3 | 34 | IPA |
| Comparative Example 4 | 34 | nBB |
| Comparative Example 5 | 34 | O-xylene |

The ingredients listed in Table 1 are as follows:
NBR: Nitrile butadiene rubber
AN: Acrylonitrile
MPK: Methyl propyl ketone
MEK: Methyl ethyl ketone
MIBK: Methyl isobutyl ketone
DIBK: Diisobutyl ketone
IPA: Isopropyl alcohol
nBB: Butyl butyrate
O-xylene: ortho-xylene

### Experimental Example 1: Evaluation of Interparticle Cohesive Force

Using a surface and interfacial cutting analysis system (SAICAS), a horizontal force measured while horizontally scratching an upper portion of the electrolyte layer applied to a substrate to a depth of 10 μm was measured, and the measured horizontal force was interpreted as an interparticle cohesive force.

The evaluation results are shown in Table 2.

### Experimental Example 2: Evaluation of NBR Binder Solubility

The binder solutions of the examples and comparative examples were uniformly mixed at room temperature using magnetic bar stirring for 48 hours to evaluate solubility.

The evaluation results are shown in Table 2, wherein ⊚ indicates complete dissolution of the binder, ∘ indicates dissolution with slight opacity, Δ indicates an opaque state, and x indicates that solubility could not be evaluated (Unmeasurable) or that the binder was not dissolved.

### Experimental Example 3: Evaluation of Oxide Dispersion Stability

Oxide dispersion stability was evaluated by adding an oxide to the binder solutions of the Examples and Comparative Examples such that the oxide content was 35 wt % relative to the total weight of the compositions for forming a solid electrolyte layer, followed by mixing by ball milling.

The evaluation results are shown in Table 2, wherein ⊚ indicates that the oxide powder was well dispersed and no visible sedimentation or creaming was observed even after standing for 12 hours or more, ∘ indicates that a slight color change was observed over time, Δ indicates that sedimentation or creaming occurred over time, and x indicates that dispersion stability could not be evaluated or that layer separation occurred.

TABLE 2

| | Interparticle | | Oxide |
|---|---|---|---|
| | cohesive | NBR binder | dispersion |
| | force (N) | solubility | stability |
| Example 1 | 0.143 | ⊚ | ⊚ |
| Example 2 | 0.109 | ⊚ | ⊚ |
| Example 3 | 0.213 | ⊚ | ⊚ |
| Example 4 | 0.090 | ⊚ | ⊚ |
| Example 5 | 0.094 | ⊚ | ⊚ |
| Example 6 | 0.091 | Δ | ◯ |
| Example 7 | 0.412 | Δ | Δ |
| Comparative Example 1 | 0.018 | ◯ | ◯ |
| Comparative Example 2 | Unmeasurable | X | X |
| Comparative Example 3 | Unmeasurable | X | X |
| Comparative Example 4 | Unmeasurable | X | X |
| Comparative Example 5 | Unmeasurable | X | X |

Referring to Table 2, it can be seen that, for the examples in which the AN content in the NBR binder was 25 wt % to 50 wt %, the interparticle cohesive force was 0.09 N or more.

On the other hand, in Comparative Example 1, in which the AN content in the NBR binder was 18 wt %, the interparticle cohesive force was 0.018 N, corresponding to about one-eighth of the cohesive force of the Example 1. In Comparative Example 2, in which the AN content in the NBR binder exceeded 50 wt %, the binder was not sufficiently dissolved in the solvent, thereby resulting in slurry agglomeration.

In addition, in Examples 1 to 5, which included MPK, MEK, and MIBK solvents, the NBR binder exhibited the highest solubility. In contrast, in Example 6, which included a DIBK solvent, the solubility of the NBR binder was somewhat reduced.

In Comparative Examples 3 to 5, which included alcohol-based solvents, ester-based solvents and aromatic solvents, the solubility of the NBR binder was significantly reduced.

Furthermore, in Examples 1 to 5, which included MPK, MEK, and MIBK solvents, the LLZO oxide particles exhibited excellent dispersion stability, whereas in Example 6, which included a DIBK solvent, the oxide dispersion stability was somewhat reduced.

In Comparative Examples 3 to 5, which included alcohol-based solvents, ester-based solvents and aromatic solvents, the oxide dispersion stability was degraded and phase separation occurred.

In Example 7, in which the AN content in the NBR binder exceeded 40 wt %, the interparticle cohesive force was excellent; however, the solubility of the NBR binder and the oxide dispersion stability were inferior to those in Examples 1 to 5.

The contents described above are merely examples of applying the principles of the present disclosure, and other configurations may be further included without departing from the scope of the present disclosure.

1. A composition for forming a solid electrolyte layer, comprising:
a ketone-based solvent;
a nitrile butadiene rubber binder; and
inorganic electrolyte particles,
wherein the acrylonitrile content in the nitrite butadiene rubber is 25% by weight to 50% by weight.

2. The composition for forming a solid electrolyte layer according to claim 1, wherein the nitrite butadiene rubber comprises hydrogenated nitrile butadiene rubber.

3. The composition for forming a solid electrolyte layer according to claim 1, wherein the ketone-based solvent comprises at least one selected from the group consisting of methyl ethyl ketone, methyl propyl ketone, and methyl isobutyl ketone.

4. The composition for forming a solid electrolyte layer according to claim 1, wherein the inorganic electrolyte particles comprise an oxide based inorganic electrolyte.

5. The composition for forming a solid electrolyte layer according to claim 4, wherein the oxide-based inorganic electrolyte comprises a garnet compound, a sodium super ionic conductor (NASICON) compound, a perovskite compound, a lithium super ionic conductor (LISICON)-based compound, a lithium phosphorus oxynitride (UPON) based compound, Li₃BO_{2.5}N_{0.5}, Li₉SiAlO₈, or a combination thereof.

6. The composition for forming a solid electrolyte layer according to claim 4, wherein the oxide-based inorganic electrolyte comprises at least one selected from the group consisting of an LLTO-based compound, an LLZO-based compound, a LATP-based compound, and an LAGP-based compound.

7. The composition for forming a solid electrolyte layer according to claim 4, wherein the oxide-based inorganic electrolyte comprises an LLZO compound.

8. The composition for forming a solid electrolyte layer according to claim 7, wherein a weight ratio of nano-LLZO to micro-LLZO in the LLZO-based compound is 1:1 to 1:5.

9. The composition for forming a solid electrolyte layer according to claim 1, wherein the viscosity of the composition is 300 cp to 5000 cp.

10. The composition for forming a solid electrolyte layer according to claim 1, wherein the cohesive force of the composition is 0.1 N or more.

11. A solid electrolyte layer comprising:
a ketone-based compound;
a nitrile butadiene rubber, and
inorganic electrolyte particles.

12. The solid electrolyte layer according to claim 11, wherein the acrylonitrile content in the nitrite butadiene rubber is 28% by weight to 40% by weight.

13. The solid electrolyte layer according to claim 11, wherein the nitrile butadiene rubber comprises hydrogenated nitrile butadiene rubber.

14. The solid electrolyte layer according to claim 11, wherein the ketone based compound comprises at least one selected from the group consisting of methyl ethyl ketone, methyl propyl ketone, and methyl isobutyl ketone.

15. The solid electrolyte layer according to claim 11, wherein the inorganic electrolyte particles comprise an oxide-based inorganic electrolyte.

16. The solid electrolyte layer according to claim 15, wherein the oxide-based inorganic electrolyte comprises a garnet compound, a sodium super ionic conductor (NASICON) compound, a perovskite compound, a lithium super ionic conductor (LISICON)-based compound, a lithium phosphorus oxynitride (UPON) based compound, Li₃BO_{2.5}N_{0.5}, Li₉SiAlO₈, or a combination thereof.

17. The solid electrolyte layer according to claim 15, wherein the oxide-based inorganic electrolyte comprises at least one selected from the group consisting of an LLTO-based compound, an LLZO-based compound, a LATP-based compound, and an LAGP-based compound.

18. The solid electrolyte layer according to claim 15, wherein the oxide-based inorganic electrolyte comprises an LLZO-based compound.

19. The solid electrolyte layer according to claim 18, wherein a weight ratio of nano-LLZO to micro-LLZO in the LLZO-based compound is 1:1 to 1:5.

20. A lithium secondary battery comprising:
a cathode;
an anode disposed opposite the cathode; and
the solid electrolyte layer according to claim 11 interposed between the cathode and the anode.
